(19) United States
(12) Patent Application Publication
(10) Pub. No.: US 2023/0417623 A1
(43) Pub. Date: Dec. 28, 2023

(54) LEAKAGE DETECTOR

(71) Applicant: Hak Soo Kim, San Diego, CA (US)

(72) Inventor: Hak Soo Kim, San Diego, CA (US)

(21) Appl. No.: 18/341,727

(22) Filed: Jun. 26, 2023

(30) Foreign Application Priority Data
Jun. 27, 2022 (KR) 10-2022-78008

(51) Int. Cl. G01M 3/28; H02J 7/14; H02J 7/02

(52) U.S. Cl. CPC G01M 3/2807; H02J 7/02; H02J 7/1415

(57) ABSTRACT

The leakage detector according to the present invention comprises a housing; wherein the housing further comprises a flow passage section penetrating the housing; a measurement section connected to one side of the flow passage section to measure the flow of the fluid passing through the flow passage section to detect any leakage of the fluid; a control section connected to the measurement section to process data obtained by the measurement section; a battery section provided to supply power to the measurement section and the control section; and a self-power generation section connected to the flow passage section to create its own energy to charge the battery section using the flow of the fluid.

### CROSS-REFERENCE TO RELATED APPLICATIONS

Any and all priority claims identified in the Application Data Sheet, or any correction thereto, are hereby incorporated by reference under 37 CFR 1.57. This application claims the benefit of S. Korea Non-Provisional Application No. 10-2022-78008 filed on Jun. 27, 2022, respectively. The aforementioned applications are incorporated by reference herein in their entirety, and are hereby expressly made a part of this specification.

### FIELD OF THE INVENTION

The present invention relates to a leakage detector, and more particularly, to a leakage detector, installed on one end of a pipe supplying inlet water to a device such as a toilet bowl or sprinkler to quickly identify and process a leakage which is otherwise difficult to visually check, detect the source of leak and promptly respond when it occurs. The said leakage detector can be used semi-permanently by continuously charging its battery which supplies power to electrically control each component.

### BACKGROUND OF THE INVENTION

With the improvement of living standards, the use of water is increasing every year. Water pipes for supplying water are generally hidden or buried underground, and the hidden or buried water pipes leak due to various factors such as impact and aging.

Leakage occurs not only in buried water pipes, but also in devices that use water at regular intervals or in a certain amount, such as toilets and sprinklers, which are widely used in day-to-day life. Such devices have another problem wherein water from the leakage permeates into walls, floors, underground, etc., making it difficult for the user to visually check or find the leak unless it gives rise to another problem of mold or flaking paint on the walls or damaged floors.

Accordingly, it is difficult for the user to recognize the leakage especially if it is small leak, and in turn, leakage continuously occurs thereby increasing the amount of water consumed meaninglessly. In addition, the user's water bill increases and there is wastage of water too due to the continuous leakage.

Patent Application KR 10-2358530 describes a leakage detection device which uses a leak vibration sound wave to detect any leakage. However, it does not promptly detect the leakage and informs the user about the leak.

Thus, there is a need for a device capable of quickly detecting leakage and accurately notifying the user about the leakage so that the user can take prompt action.

### SUMMARY OF THE INVENTION

This Summary is provided to introduce a selection of concepts in a simplified form that are further described below in the Detailed Description of the invention. This Summary is not intended to identify key aspects or essential aspects of the claimed subject matter. Moreover, this Summary is not intended for use as an aid in determining the scope of the claimed subject matter. The object of the present invention is not limited thereto, and other objects not mentioned will be clearly understood by those skilled in the relevant field of technology from the following descriptions.

The present invention discloses a leakage detector device to detect any leakage in a device that is difficult to visually check, identify and correct the leakage. The leakage detector disclosed herein is easy to use, light, and conveniently connects to a device to detect any leakage thereby allowing the user to promptly responds to any leakage therein.

An object of the present invention is to provide a leakage detector device to quickly detect, identify and process leakage wherein the said leakage detector is installed on one end of a pipe supplying inlet water to a device with leakage.

It is another object of the invention to provide a leakage detector comprising a housing, a flow passage section, a measurement section, a control section, a battery section and a self-power generation section.

It is a further object of the invention to provide the measurement section further comprising a rotation axis rotatably coupled to one side of the flow passage section, a rotor provided on one end of the rotation axis inserted into the flow passage section and rotatably coupled by the flow of the fluid, and a sensor unit provided on one side of the rotation axis and detecting rotation of the rotation axis.

It is yet another object of the invention to provide the self-power generation section further comprising a generator provided at the other end of the rotation axis opposite to the rotor to convert the rotatory power of the rotor into electrical energy, and a rectifier provided between the generator and the battery section to convert electrical energy generated by the generator into power usable by the battery section.

It is still another object of the invention to provide a leakage detector further comprising a charging section located between the rectifier and the battery section for storing power and charging the battery section. In addition, the charging section may further comprise a charging terminal exposed to the outside of the housing in order to charge through an external power supply.

It is an additional object of the invention to provide the control section further comprising a telecommunication module for transmitting and receiving the measurement data measured by the measurement section.

There is disclosed a leakage detector to detect leaks comprising a housing, wherein the said housing further comprises a hollow cylindrical flow passage section penetrating the housing so that fluid can flow through it, wherein the flow passage section protrudes from both ends of the housing at a predetermined length; a measurement section inside the housing to measure the flow of the fluid passing through the flow passage section to detect leakage of the fluid, wherein the measurement section is connected to one side of the flow passage section; a control section inside the housing to process data measured by the measurement section, wherein the said control section is connected to the measurement section; a battery section inside the housing to supply power to the measurement section and the control section; and a self-power generation section inside the housing to create its own energy using the flow of the fluid to charge the battery section, wherein the said self-power generation section is connected to one side of the flow passage section.

These together with other objects and advantages which will become subsequently apparent reside in the details of the invention as more fully described and claimed, reference being had to the accompanying drawings forming a part thereof, wherein like numerals refer to like parts throughout.

### BRIEF DESCRIPTION OF THE DRAWINGS

The novel features of the invention, as well as the invention itself, both as to its structure and its operation will be best understood from the accompanying drawings, taken in conjunction with the accompanying description, in which similar reference characters refer to similar parts, and in which:

FIG. 1 shows a perspective view of the leakage detector according to the present invention;

FIG. 2 shows a schematic block circuit diagram of the leakage detector according to the present invention; and

FIG. 3 shows a cross-sectional view of the leakage detector displaying the measurement section according to the present invention.

### DETAILED DESCRIPTION OF THE INVENTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skill in the art without departing from the scope of the invention.

Terms used herein are for describing the embodiments and do not intend to limit the present invention. Unless otherwise defined, all terms (including technical and scientific terms) used in this specification may be used with meanings commonly understood by those skilled in the art to which the present invention belongs. In this specification, the singular form also includes the plural form unless otherwise specified in the phrase. As used herein, “comprises” and/or “comprising” does not exclude the presence or addition of one or more other elements other than the recited elements. Like reference numerals throughout the specification refer to like elements, and “and/or” includes each and every combination of one or more of the recited elements. Although “first”, “second”, etc. are used to describe various elements, these elements are not limited by these terms. These terms are only used to distinguish one element from another. Accordingly, it goes without saying that the first element mentioned below may also be the second element within the technical idea of the present invention.

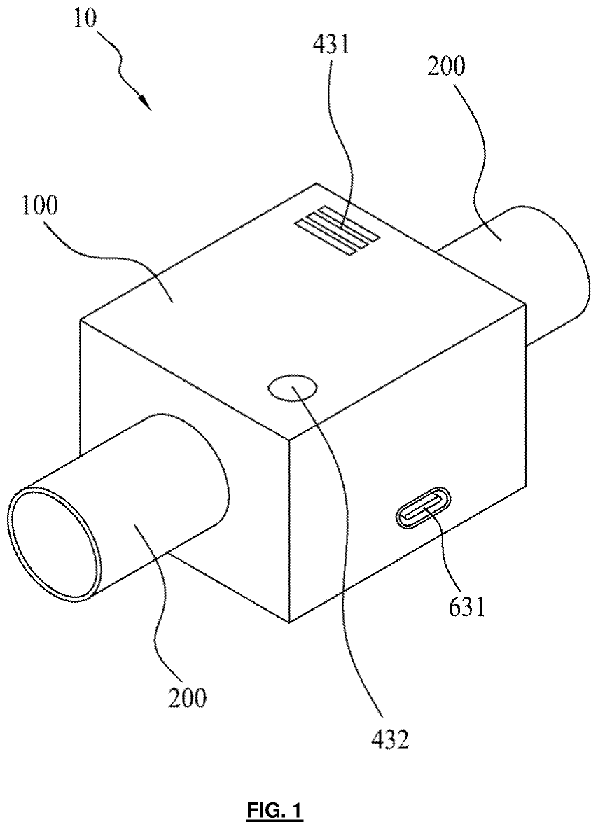

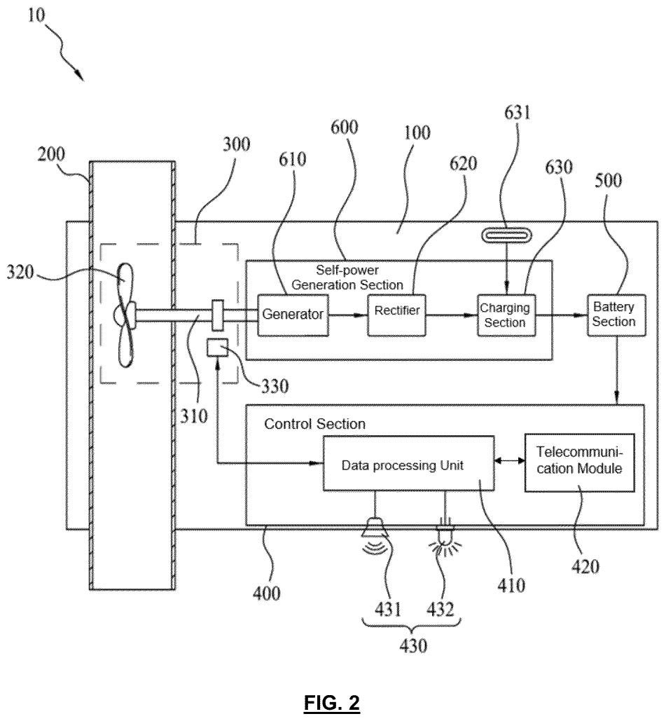

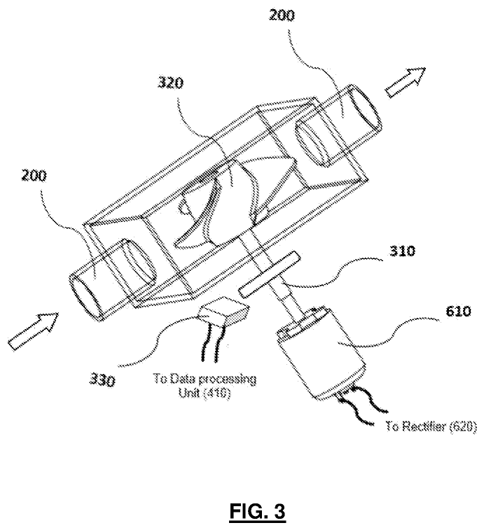

As shown in FIGS. 1-3, the leak detector (10) disclosed in the present invention is a device that detects leak or leakage of fluid passing through a pipe in various devices, such as a toilet or a sprinkler, that consumes fluid for a certain amount of time or in a certain quantity when used. As shown in FIGS. 1 and 2, the leakage detector (10) is made up of a housing (100) comprising a flow passage section (200), a measurement section (300), a control section (400), a battery section (500), and a self-power generation section (600).

The housing (100) forms the appearance of the leakage detector (10) and provides a space in which each component aforementioned may be seated. The housing (100) may be formed in various sizes and shapes in consideration of the diameter, capacity, etc. of a flow passage pipe in various devices to be installed. Any device of any shape or size may be used for the housing (100) of the leakage detector (10) as long as it provides a space in which each component described herein can be safely seated.

As can be seen in FIG. 1, the flow passage section (200) is provided to pass through one face of the housing (100) on one end and out the opposite face of the housing (100) on the other end. Each end of the flow passage section is coupled to one end of a pipe of a device capable of supplying water such as, a toilet or a sprinkler. The flow passage section (200) connects the leakage detector (10) and the pipe of a device. The flow passage section (200) is preferably hollow so that a fluid such as, but not limited to, water can flow. The flow passage section (200) is cylindrical in shape wherein both ends of the flow passage section (200) may be coupled to either one end of the hose connected to the toilet, or sprinkler, etc. or one end of the connection part where the inlet pipe and the connecting hose of the toilet, or sprinkler, etc. are connected, and one end of the inlet pipe that supplies water thereto. In addition, both ends of the flow passage section (200) are provided to be exposed to the outside of the housing (100) at predetermined lengths because they must be connected to a hose or an inlet pipe. The length, diameter, cross-sectional shape, etc. of the flow passage section (200) may be formed in various ways according hoses or pipes of device in which leakage can occur.

The leakage detector (10) further comprises a measurement section (300) provided in close contact with or adjacent to the flow passage section (200) inside of the housing (100). The measurement section (300) is a device to measure the flow of substance such as the flow rate and flow velocity, etc. passing through the inside of the flow passage section (200). Any measuring device may be used as the measurement section (300) as long as it can accurately measure the flow, flow rate, flow velocity, etc. of the substance passing through the flow passage section. The measurement section (300) may further comprise a rotor (320), a rotation axis (310), and a sensor unit (330).

One end of the rotation axis (310) in the measurement section (300) is inserted to a predetermined depth into the flow passage section (200), preferably, in the center of the flow passage section (200). The rotation axis (310) is rotatable and it is coupled using a sealed bearing to enable stable rotation so that the fluid flowing through the flow passage section (200) does not leak.

The measurement section (300) further comprises a rotor (320) device inserted inside the flow passage section (200) and it is attached to one end of the rotation axis (310) which is inside the housing (100). The rotor (320) is rotated by the substance flowing through the flow passage section (200) to rotate the rotation axis (310). The size of the rotor (320), the number of blades, etc. may be varied and can be decided as per the device in which it is determined to be used to detect any leaks.

The sensor unit (330) is a sensor that is provided on one side of the rotation axis (310) to detect the rotation of the rotation axis (310) rotating together with the rotor (320) which in turn is rotated by the substance flowing through the flow passage section (200). In one embodiment, the sensor unit (330) may be a reflective sensor device that measures light reflected from a reflector installed on the rotation axis (310). In another embodiment, a transmissive sensor device that forms slots at regular intervals in a rotating disk installed on the rotation axis (310) and measures the light sources passing through these slots. In addition to these sensor devices, any other sensor may also be used as long as it can accurately measure the rotation of the rotation axis (310).

The control section (400) of the housing (100) is a device that is provided inside the housing (100) and it is connected to the measurement section (300) in a transmission/reception manner, wherein it transmits control information to the measurement section (300), and receives measurement information from the measurement section (300), and processes the transmitted measurement information. The control section (400) may further comprise a data processing unit (410), a telecommunication module (420), a notification unit (430).

The data processing unit (410) located inside the housing (100) of the leakage detector (10) is configured to be electrically connected to the sensor unit (330) of the measurement section (300) and controls the sensor unit (330) wherein it receives and analyzes measurement information measured by the sensor unit (330). The data processing unit (410) is used for processing the measurement information transmitted from the measurement section (300) or transmitting a control signal to the measurement section (300). For the purposes of this invention, any device may be used as long as it can perform these functions, but it is preferable to use a data processing device such as a central processing unit (CPU) in which a program for analysis and control is previously input.

The telecommunication module (420) is connected to the data processing unit (410) to transmit information collected and analyzed by the data processing unit (410) to the user, and transmits and receives information for receiving a control signal to control the sensor unit (330) from an external terminal such as a user terminal. As such, the telecommunication module (420) may be any device as long as it is a device that allows the user to mutually transfer information with the terminal, such as the control section (400) and the mobile phone, but it is preferable to use a wireless communication device for convenience of use, and a low-power product such as, but not limited to, a low-power Wi-Fi module, a low-power Bluetooth module, or a ZigBee communication module in consideration of the efficiency of the battery section (500).

The notification unit (430), inside the housing (100) of the leakage detector (10), is electrically connected to the data processing unit (410) to audibly or visually display the current state of the leakage detector (10) and whether or not the leakage is detected. The notification unit (430) may be any device as long as it can quickly transmit the current state of the leakage detector (10) and detection of any leaks to the user. In one embodiment, the notification unit (430) may be composed of an indicator lamp (432) and a speaker (431) as shown in FIGS. 1 & 2. The speaker (431) refers to any mechanical, electromechanical or piezoelectric device that generates various voices or electronic sounds, such as, but not limited to a buzzer or beeper, and the indicator lamp (432) refers to any device that generates visual notifications through various colors or flickering, such as, but not limited to, a LED indicator lamp.

The battery section (500) is a device provided inside the housing (100) to supply power to the control section (400) and the measurement section (300). It is electrically connected to the control section (400). For the convenience of use, the battery section (500) is preferably a portable battery section or a rechargeable battery section, preferably made of the rechargeable battery section.

The self-power generation section (600) is a device for storing electricity and charging the battery section (500) with electricity generated by using the flow of fluid flowing through the flow passage section (200). The self-power generation section (600) may be any device as long as it is capable of self-power generation using the flow of fluid. In one embodiment, the self-power generation section (600) may comprise a generator (610), a rectifier (620), and a charging section (630).

As shown in FIGS. 2 & 3, the generator (610) is a device that is coupled to one end of the rotation axis (310) to which the rotor (320) of the measurement section (300) is coupled and converts rotational energy generated by the rotor (320) and the rotation axis (310) rotated by the flow of substance into electrical energy. This generator (610) may be directly coupled to the rotation axis (310) or connected through a gearbox or the like to improve power generation efficiency.

The rectifier (620) is a device that converts electrical energy generated by the generator (610) into power usable by the battery section (500). The charging section (630) is a device that stores electrical energy converted by the rectifier (620) and transfers the stored energy to the battery section (500) to charge the battery section (500). The charging section (630) may further comprise a charging terminal (631) exposed to the outside of the housing (100) so as to charge using an external power supply when the self-power generation section (600) is not used for a long time, or when the battery section (500) and charging section (630) are both discharged, such as initial use of the device.

In one embodiment, the self-power generation section (600) may be provided with a rotor and a rotation axis separately from the measurement section (300), thereby increasing the power generation by increasing the number of rotors and rotation axes.

The self-power generation section (600) uses the rotor (320) and the rotation axis (310) of the measurement section (300), thus, by configuring the use of self-power generation section (600) and the measurement section in combination, the number of components constituting the product is reduced and the overall volume of the product is reduced accordingly, thereby reducing the probability of component failure.

When inlet water is supplied to the toilet or sprinkler, the fluid flows into the flow passage section (200), and the rotor (320) is rotated by the fluid flow which in turn rotates the rotation axis (310) connected to the rotor (320), and the generator (610) converts the rotatory power of the rotation axis (310) into electrical energy thereby generating electricity. The power generation efficiency of the generator (610) may be improved by increasing the rotational frequency of the rotation axis (310) through a gearbox or the like and transferring the same to the generator (610).

The electrical energy generated through the generator (610) is converted into usable power in the battery section (500) by the rectifier (620) and transferred to the battery section (500) via the charging section (630) to charge the battery section (500). If the battery section (500) is fully charged, a predetermined amount of electrical energy may be stored by accumulating in the charging section (630), or the charging may be stopped by recognizing the fully charged state of the battery section (500).

The leakage detector disclosed in the present invention maximizes the convenience of use by utilizing a built-in battery section to supply electricity consumed by the control section, notification unit, sensor, etc. without connecting to an external power supply. Thus, the leakage detector can be used semi-permanently without connecting an external power supply, as it charges the built-in battery section through self-power generation wherein electrical energy is continuously generated by using the rotatory power of the rotor (320) and the rotation axis (310) in the self-power generation section (600).

The leakage detector (10) disclosed in the present invention may generate power on its own through the self-power generation section (600) especially when power is not continuously supplied from the outside to charge the battery section (500) that supplies power to other components of the leakage detector thereby reducing power consumption.

According to the present invention, the leakage detector (10) can detect leaks of any kind, such as, but not limited to water, gas, or air. In case of fluid leaks, the leakage director of the present invention is connected to a device such as a toilet or a sprinkler where it is not easy for the user to visually check the leakage.

In one embodiment, the leakage detector disclosed in the present invention is connected to a toilet to detect any leakage therein. In the toilet, when a user flushes water for discharge of contents of the toilet bowl, the supply of inlet water is stopped after a certain amount of inlet water is supplied according to the capacity of the toilet. One end of the flow passage (200) of the leakage detector (10) is connected to one end of the inlet pipe or connection hose, and the other end of the flow passage (200) is connected to the toilet where the inlet pipe or connection hose was previously connected. In order to prevent damage to the inlet pipe, connecting hose or toilet, it is preferable to install the leakage detector (10) after carefully disassembling the said parts from the toilet.

In a toilet bowl, the supply of inlet water is expected to stop after a certain amount of inlet water flows, however, the inlet water is continuously supplied when leakage occurs in the toilet bowl. It is not easy for the user to visually determine where the water leakage is occurring as water leakage often occurs inside and the water usually does not flow out of the toilet and onto the bathroom floor.

When the user does not use the toilet and there is no leakage, inlet water is not supplied to the toilet, so inlet water filled inside the flow passage section (200) of the housing of the leakage detector does not flow. Accordingly, the rotation axis (310) connected to the rotor (320) and the rotor (320) installed inside the flow passage section (200) does not rotate, the measurement sensor of the measurement section (300) for measuring the rotation of the rotation axis (310) does not detect any particular information.

Thereafter, when the user discharges the water stored in the toilet after using the toilet, new inlet water is supplied to the toilet. Accordingly, as the inlet water flows into the toilet through the inlet pipe, the flow of the inlet water occurs inside the flow passage section (200) as well. The rotor (320) and the rotation axis (310) are rotated by the flow of inlet water inside the flow passage section (200), and the sensor unit (330) of the measurement section (300) measures the flow state of the inlet water through the rotational frequency and rotational speed of the rotation axis (310), and transmits this measurement information to the control section (400).

The control section (400) may check information about the flow rate and velocity of the inlet water supplied to the toilet through the measurement information transmitted from the measurement section (300). In one embodiment, the capacity of the toilet is about 6 Liters, and the control section (400) may determine whether 6 Liters of inlet water has been supplied by calculating the flow rate, flow velocity, supply time, etc. based on the information transmitted from the measurement section (300). In the present invention, for convenience of description, it will be described assuming that the flow rate of 6 Liters is supplied to the toilet for 30 seconds and the rotation axis (310) rotates 150 times. That is, when no leakage occurs, the rotation axis (310) does not rotate after 30 seconds of supplying 6 Liters of inlet water or 150 rotations of the rotation axis (310), and if the measurement result in the measurement section (300) corresponds to this, the control section (400) determines that there is no leakage in the toilet and that it is operating normally. In this case, the control section (400) may not receive separate information, or may transmit information indicating that the toilet is normally operating without leakage to the user terminal through the telecommunication module (420) at every previously input period. The indicator lamp (432) included in the notification unit (430) may be displayed with a green light turned on so that the user may visually check it.

However, when more than 6 Liters of inlet water is supplied for more than 30 seconds, or if the rotation axis (310) rotates more than 150 times, the control section (400) determines that water leakage has occurred. In this case, the control section (400) may immediately transmit an abnormal signal from the data processing unit (410) to the user terminal using the telecommunication module (420). In addition, the indicator lamp (432) included in the notification unit (430) turns red to visually display it, and the abnormal signal is generated so that an audible confirmation may be made through the speaker (431). As such, if inlet water exceeding the reference value is supplied or if inlet water is continuously supplied, the control section (400) determines that water leakage occurs, and immediately transmits the water leakage information to the user using the telecommunication module (420), and at the same time, outputs the abnormality through a notification unit (430), so the user can quickly check and correct the leakage in the toilet. The leakage detector of the present invention detects any leakage and quickly notifies the user thereby helping in reducing the wastage of water and preventing an increase in the user's water bill.

Likewise, the leakage detector (10) disclosed in the present invention can be used to detect water leakage in a sprinkler through the same process. In the case of a sprinkler, it is often set to automatically shut off after supplying a predetermined amount of water for a predetermined period of time to a garden. The user may input the preset cycle of the sprinkler and the spraying time when using the sprinkler into the control section (400) through a user terminal. In one embodiment, the sprinkler is set to be sprayed once a day at a designated time for about 15 minutes, and this setting information is input to the control section (400).

Accordingly, the control section (400) receives the measurement information from the measurement section (300) in real-time, and if the rotation of the rotation axis (310) is measured by the measurement section (300) for a time other than the designated time, that is, a time other than the time zone set by the user, the control section (400) determines it as water leakage, and the data processing unit (410) transmits water leakage information through the telecommunication module (420) and the notification unit (430) to the user.

In addition, when the rotation information of the rotation axis (310) generated in the measurement section (300) exceeds the designated time of 15 minutes is transmitted, the control section (400) determines that it is water leakage and transmits the leakage information to the user through the telecommunication module (420) and the notification unit (430).

Accordingly, the leakage detector (10) may detect the water leakage by measuring either the quantity of inlet water having a reference capacity is supplied to the toilet bowl or sprinkler, or the time period more than a reference time for which the inlet water continuously flows.

Although the leakage detector (10) according to the present invention has been described with a focus on leaking fluids, however, it may be utilized to measure other kind of leaks such as gas, air, oil.

The leakage detector of the present invention is not bulky, and anyone can easily connect it to the inlet pipe or the connecting hose of the device being examined by coupling the flow passage section of the leakage detector in the same way as the general drain pipe coupling method.

As described above, those skilled in the art to which the present invention pertains will understand that the present invention may be embodied in other specific forms without changing the technical idea or essential features thereof. Therefore, it should be understood that the above-described embodiments are illustrative and not limited in all respects. The scope of the present invention is indicated by the claims to be described later rather than the detailed description, and all changes or modifications derived from the meaning and scope of the claims and equivalent concepts should be construed as being included in the scope of the present invention.

1. A leakage detector to detect any leakage comprises a housing, wherein the said housing comprises:
a hollow cylindrical flow passage section penetrating the said housing so that fluid can flow therein, wherein the flow passage section protrudes from both ends of the housing at a predetermined length;
a measurement section to measure the flow of the fluid passing through the flow passage section to detect leakage of the fluid, wherein the measurement section is connected to one side of the flow passage section;
a control section to process data measured by the measurement section, wherein the said control section is connected to the measurement section a battery section to supply power to the measurement section and the control section; and
a self-power generation section to create its own energy using the flow of the fluid to charge the battery section, wherein the said self-power generation section is connected to one side of the flow passage section.

2. The leakage detector of claim 1, wherein the said measurement section further comprises a rotor inserted into the center of the flow passage section and rotatably coupled by the flow of the fluid;
a rotation axis, wherein one end of the rotation axis attaches in the center of the rotor; and
a sensor unit provided on one side of the rotation axis, wherein the said sensor unit detects the rotation of the rotor and the rotation axis.

3. The leakage detector of claim 1, wherein the said self-power generation section further comprises a generator provided on the other end of the rotation axis to convert the rotatory power of the rotor into electrical energy;
a rectifier provided between the said generator and the said battery section to convert electrical energy generated by the generator into power usable by the said battery section; and
a charging section between the rectifier and the battery section, wherein the said charging section stores power and charges the battery section.

4. The leakage detector of claim 3, wherein the said charging section further comprises a charging terminal on the outside of the housing to charge through an external power supply.

5. The leakage detector of claim 1, wherein the said control section further comprises a telecommunication module for transmitting and receiving data obtained by the measurement section.

6. A process to detect leakage using the leakage detector of claim 1, wherein one end of the flow passage section connects to one end of the inlet pipe or connection hose, and the other end of the flow passage section connects to a device where the inlet pipe or connection hose was previously connected; wherein the flow of inlet water inside the flow passage section rotates the rotor and the rotation axis; wherein the sensor unit measures the flow state of the inlet water through the rotational frequency and rotational speed of the rotation axis and transmits the measured information to the control section; and wherein the control section further transmits the information about the leakage through the telecommunication module.
